(19) United States
(12) Patent Application Publication
(10) Pub. No.: US 2011/0106562 A1
(43) Pub. Date: May 5, 2011

(54) PLANNING A RADIATION TREATMENT

(76) Inventors: Kamalakar C. Gogineni, Cupertino, CA (US); Tilak B. Kasturi, Palo Alto, CA (US)

(21) Appl. No.: 12/916,408

(22) Filed: Oct. 29, 2010

Related U.S. Application Data
(60) Provisional application No. 61/257,012, filed on Nov. 1, 2009.
(60) Provisional application No. 61/257,014, filed on Nov. 1, 2009.
(60) Provisional application No. 61/257,016, filed on Nov. 1, 2009.

(51) Int. Cl. G06Q 50/00

(52) U.S. Cl. 705/3

(57) ABSTRACT

In a method for planning a radiation treatment, a treatment plan request is received. The treatment plan request includes patient identification information for a patient, the treatment plan request for requesting creating of a treatment plan for use in radiation therapy. Patient files corresponding to the patient are received, the patient files including information for use in creating the treatment plan. A service provider is selected for creating a treatment plan. The service provider is provided access to the patient files and the treatment plan request.

### RELATED U.S. APPLICATIONS

This application claims priority to the co-pending provisional patent application Ser. No. 61/257,012, Attorney Docket Number RADI-P01-PRV, entitled “METHOD AND SYSTEM FOR PROVIDING A RADIATION TREATMENT PLANNING SERVICE,” by Gogineni, et al., with filing date Nov. 1, 2009, which is herein incorporated by reference in its entirety, claims priority to the co-pending provisional patent application Ser. No. 61/257,014, Attorney Docket Number RADI-P02-PRV, entitled “METHOD AND SYSTEM FOR CREATING A TUMOR TREATMENT PLAN,” by Kresl, et al., with filing date Nov. 1, 2009, which is herein incorporated by reference in its entirety, and claims priority to the co-pending provisional patent application Ser. No. 61/257,016, Attorney Docket Number RADI-P01-PRV, entitled “METHOD AND SYSTEM FOR ROUTING A REMOTE TREATMENT PLAN REQUEST,” by Kasturi, et al., with filing date Nov. 1, 2009, which is herein incorporated by reference in its entirety.

### BACKGROUND

Radiation oncology is a cancer treatment that applies a prescribed dose of radiation to a malignant tumor in an attempt to control the cancerous cells. Radiation oncology typically involves the collaboration of a physician, a medical physicist, and a dosimetrist. A dosimetrist is a medical professional responsible for determining radiation dose distributions and dose calculations for use in radiation therapy.

Ideally, the radiation dose is distributed and applied in a strategic manner that spares normal healthy tissue near the tumor as much as possible. To achieve this goal, the dosimetrist typically creates a radiation treatment plan that defines radiation dose distributions through application of shaped radiation beams of varied intensities and/or multiple angles of exposure. Attacking a tumor from various angles such that the shaped radiation beams intersect at the target tumor causes the tumor to absorb a larger dose of radiation than in the surrounding healthy tissue.

### BRIEF DESCRIPTION OF THE DRAWINGS

The accompanying drawings, which are incorporated in and form a part of this application, illustrate embodiments of the subject matter, and together with the description of embodiments, serve to explain the principles of the embodiments of the subject matter. Unless noted, the drawings referred to in this brief description of drawings should be understood as not being drawn to scale.

FIG. 1 is a flow chart of an example method for providing a radiation treatment planning service, in accordance with an embodiment.

FIG. 2A is an example schematic for creating a treatment plan request, in accordance with an embodiment.

FIG. 2B is a flow chart 250 of an example method for creating a treatment plan request, in accordance with various embodiments.

FIG. 3A is a flow diagram of an example schematic for creating a treatment plan request and receiving a set of patient files, in accordance with an embodiment.

FIG. 3B is a block diagram of an example electronic medical system, in accordance with an embodiment.

FIG. 3C is a flow chart of an example method for retrieving a set of patient files corresponding to the patient from an electronic medical record system, in accordance with various embodiments.

FIG. 4A is a flow chart of an example method for receiving a set of patient files, in accordance with an embodiment.

FIG. 4B is a flow diagram of an example schematic for receiving a set of patient files, in accordance with an embodiment.

FIG. 4C is a block diagram of an example schematic for receiving a set of patient files, in accordance with an embodiment.

FIG. 5 is a flow chart of an example method for selecting a global service provider, in accordance with an embodiment.

FIG. 6 is a flow chart of an example method for providing a recommended treatment plan, in accordance with an embodiment.

FIG. 7 is an example graphical representation for monitoring status of the treatment plan request, in accordance with an embodiment.

FIGS. 8A and 8B are example schematics of server architectures, in accordance with various embodiments.

FIG. 9 is an example schematic of a network, in accordance with an embodiment.

FIGS. 10A-10J are schematics illustrating an example method for providing a radiation treatment planning service.

FIG. 11 is a block diagram of an example creation of a treatment plan request, in accordance with an embodiment.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope. In some embodiments, all or portions of the electronic computing devices, units, and components described herein are implemented in hardware, a combination of hardware and firmware, a combination of hardware and computer-executable instructions, or the like. Furthermore, in the following description, numerous specific details are set forth in order to provide a thorough understanding of the subject matter. However, some embodiments may be practiced without these specific details. In other instances, well-known methods, procedures, objects, and circuits have not been described in detail as not to unnecessarily obscure aspects of the subject matter.

### Notation and Nomenclature

Unless specifically stated otherwise as apparent from the following discussions, it is appreciated that throughout the present Description of Embodiments, discussions utilizing terms such as “receiving,” “selecting,” “providing,” “interfacing,” “receiving,” “bundling,” “transferring,” “transmitting,” “searching,” “flagging,” “extracting,” “accessing,” “uploading,” “downloading,” “notifying,” “allowing,” or the like, refer to the actions and processes of a computer system or similar electronic computing device (or portion thereof) such as, but not limited to one or more or some combination of: a visual organizer system, a request generator, an Internet coupled computing device, and a computer server. The electronic computing device manipulates and transforms data represented as physical (electronic) quantities within the electronic computing device's processors, registers, and/or memories into other data similarly represented as physical quantities within the electronic computing device's memories, registers and/or other such information storage, processing, transmission, or/or display components of the electronic computing device or other electronic computing device(s). Under the direction of computer-readable instructions, the electronic computing device may carry out operations of one or more of the methods described herein.

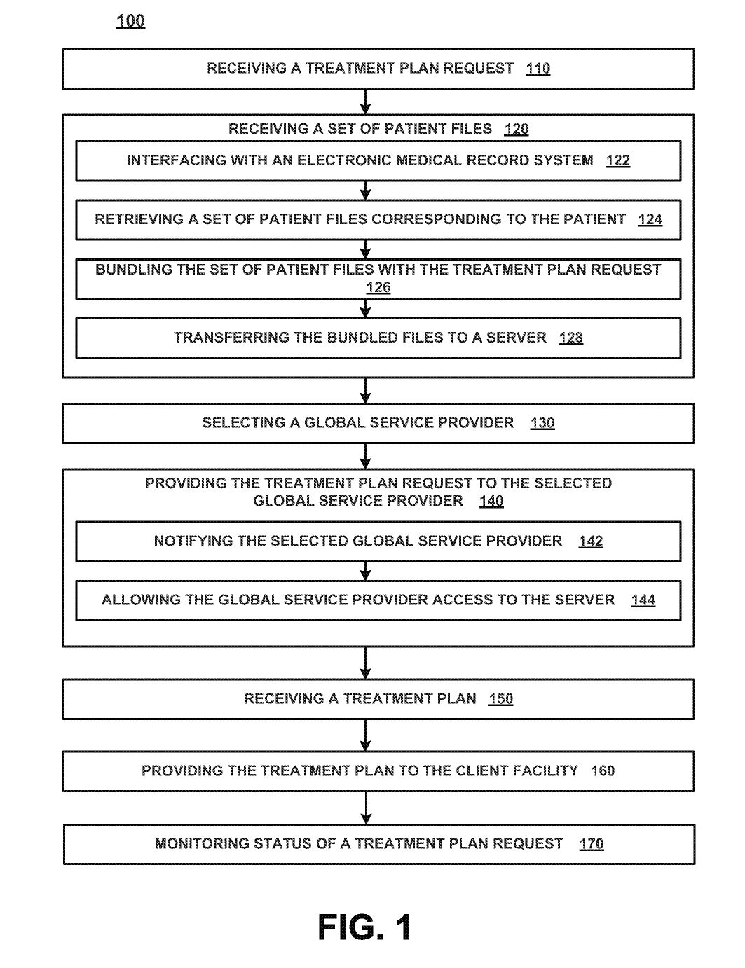

FIG. 1 is a flow chart 100 of an example method for providing a radiation treatment planning service, in accordance with various embodiments. Although specific operations are disclosed in the method of flow chart 100, such steps are examples. That is, embodiments of the present invention are well-suited to performing various other operations or variations of the operations recited in method of flow chart 100. The operations in method of flow chart 100 may be performed in an order different than presented, and it is possible that not all of the operations in method of flow chart 100 are performed. All of, or a portion of, the operations described by method of flow chart 100 may be implemented using computer-readable and computer-executable instructions which reside, for example, in computer-usable storage media of a computer system.

At operation 110 of FIG. 1, in one embodiment, a treatment plan request for a patient from a client facility is received, wherein the treatment plan request includes patient identification information. In one embodiment, receiving a treatment plan request for a patient at a client facility functions to initiate the routing of a remote treatment plan request. In one embodiment, receiving a treatment plan request includes interfacing with a treatment planning system (TPS). In one embodiment, interfacing with a TPS may include utilizing a TPS adapter such as an application programming interface (API) to communicate with the TPS.

At operation 120, in one embodiment, a set of patient files for the patient is received. At operation 130, in one embodiment, a global service provider is selected from a group of global service providers to respond to the treatment plan request. At operation 140, in one embodiment, a treatment plan request is provided to the selected global service provider. At operation 150, in one embodiment, a treatment plan is created. At operation 160, in one embodiment, the treatment plan is provided to the client facility. In various embodiments, the method of flow chart 100 further includes operation 170, in which the status of the treatment plan request is monitored.

In various embodiments, the method of flow chart 100 is performed to collaboratively generate a radiation treatment plan remotely over a network, and may be performed by a physician and/or dosimetrist, or may alternatively be performed by any suitable user for any suitable project planning application.

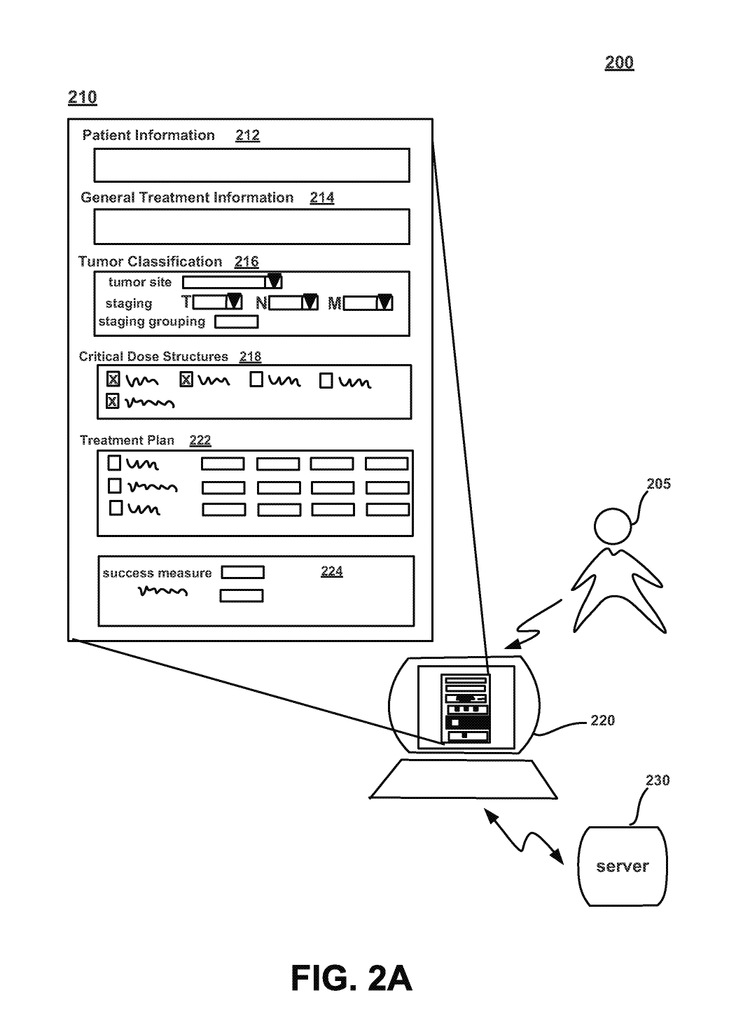

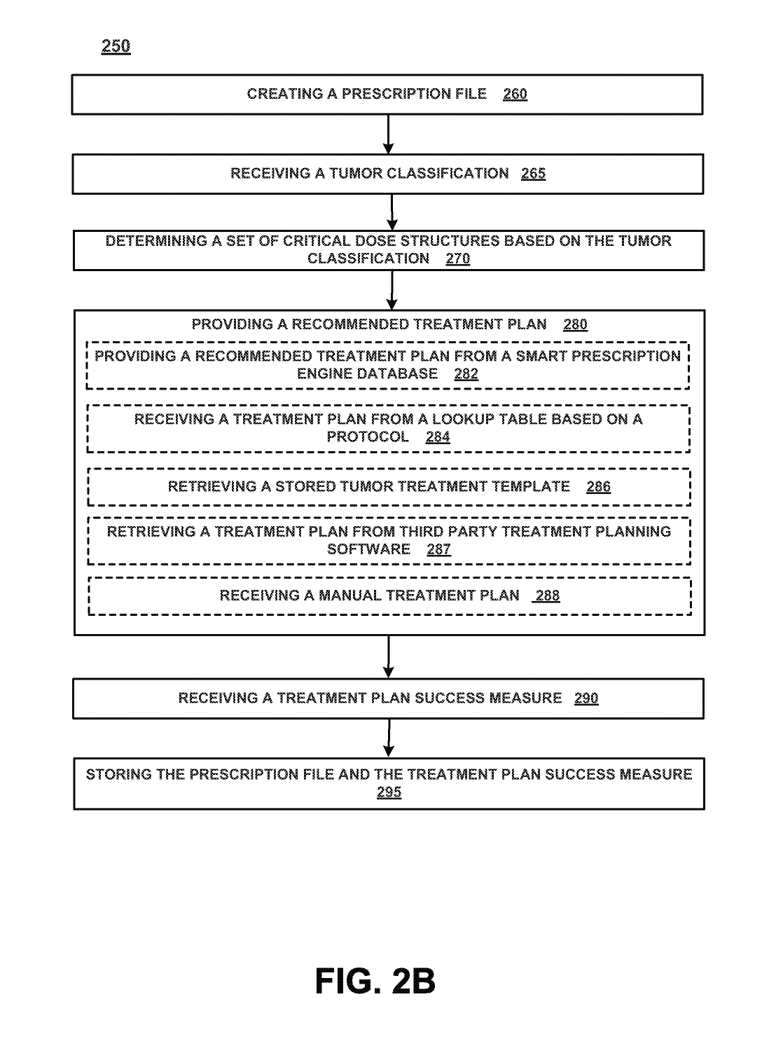

In one embodiment, receiving a treatment plan request for a patient from a client facility functions to initiate the treatment planning process. Reference will be made to elements of FIGS. 2A and 2B to facilitate the explanation of the operations of operation 110 of FIG. 1. FIG. 2A is an example schematic 200 for creating a treatment plan request, in accordance with an embodiment. FIG. 2B is a flow chart 250 of an example method for creating a treatment plan request, in accordance with various embodiments. Although specific operations are disclosed in the method of flow chart 250, such steps are examples. That is, embodiments of the present invention are well-suited to performing various other operations or variations of the operations recited in method of flow chart 250. The operations in method of flow chart 250 may be performed in an order different than presented, and it is possible that not all of the operations in method of flow chart 250 are performed. All of, or a portion of, the operations described by method of flow chart 250 may be implemented using computer-readable and computer-executable instructions which reside, for example, in computer-usable storage media of a computer system.

At operation 260, a prescription file is created. As shown in FIG. 2A, in one embodiment, the operation of creating a treatment plan request includes creating a prescription file based on information received from or entered by a user 205, for example using prescription file entry form 210. In various embodiments, creating a prescription file is performed at least once for each radiation treatment area of a patient, but may alternatively be performed once for each radiation therapy session, once for a patient, or any suitable number of times. In one embodiment, prescription file entry form 210 is accessed by user 205 using computer system 220. In one embodiment, prescription file entry form 210 is accessible through a user interface of computer system 220, such as a web browser or other online platform. In one embodiment, computer system 220 is communicatively coupled over a network to server 230. While FIG. 2A illustrates that prescription file entry form 210 is accessible through a user interface of computer system 220, it should be appreciated that the prescription file may be entered using a different software application or any suitable user interface.

The prescription file includes, but is not limited to, as illustrated in prescription file entry form 210, patient information 212, general treatment information 214, and tumor information 216. Patient information 212 may include patient name, age, date of birth, gender, patient identification number, medical record number, physician name, and/or any suitable patient information. General treatment information 214 may include types of imaging equipment used with the patient, radiation energies and radiation fields intended to treat the tumor, desired radiation dose to apply to the tumor, and/or any suitable information.

At operation 265, a tumor classification is received. Receiving a tumor classification functions to generate information identifying the kind of tumor to be treated. In various embodiments, tumor classification includes, without limitation, a tumor site classification, a tumor size measurement (either derived automatically from an image or entered by the user), and the tumor stage based on the measure of tumor size. In various embodiments, a tumor site classification preferably includes a tumor site selected from a list of tumor sites based on the American Joint Committee on Cancer classification system, but may alternatively include receiving any suitable kind of tumor site classification. In various embodiments, a tumor size measurement includes receiving values for the “T” (size of tumor), “N” (degree of spread to regional lymph nodes), and “M” (presence of metastasis) parameters of the TNM cancer staging system developed and maintained by the International Union Against Cancer. In various embodiments, the tumor stage based on the tumor size measurement includes a staging grouping from a lookup table based on the “T”, “N” and “M” parameters. A tumor size measurement may alternatively include any suitable measure of tumor size.

At operation 270, a set of critical dose structures based on the tumor classification functions to generate a list of organs and any other tissues near the tumor site that might receive radiation during radiation treatment is determined. In one embodiment, determining a set of critical dose structures includes determining a set of critical dose structures from a lookup table based on the tumor site classification and/or the measure of tumor stage grouping, and displaying the set of critical dose structures on a user interface. A tumor stage grouping includes referencing a lookup table of cancer staging based on TNM parameters of the TNM cancer staging system, but may alternatively include any suitable step for determining a tumor stage grouping.

As shown in FIG. 2A, tumor information 216 may include tumor site classification, tumor size classification, and a set of critical dose structures 218 representing healthy tissue around the tumor that ideally should have minimal radiation during radiation treatment. In one embodiment, user 205 is a physician who enters or provides information through a user interface, such as a web browser or other online platform. However, the user may be any suitable user interacting with prescription file entry form 210 is accessible through a user interface of computer system 220. It should be appreciated that user 205 may alternatively be a dosimetrist or any suitable user

As shown in FIG. 2A, the treatment plan request is created in response to input of a user 205 who is operating a user interface such as a web browser or software application. In one embodiment, the user interface is communicatively coupled to a data center, which may be a local server or a remote server, through cloud computing or any suitable network.

In various embodiments, the treatment plan request includes, without limitation, patient identification information such as name, patient identification number, and/or any suitable identification information. The treatment plan request may further include metadata specific to the client facility, such as a treatment plan request identification number and/or identification of the client facility. In one embodiment, the treatment plan request is a tumor treatment plan request, and may include a prescription for radiation dosage to apply to the tumor, and general information on the tumor, such as values for the TNM parameters of the TNM cancer staging system, but may alternatively include any suitable information related to generating a tumor treatment plan.

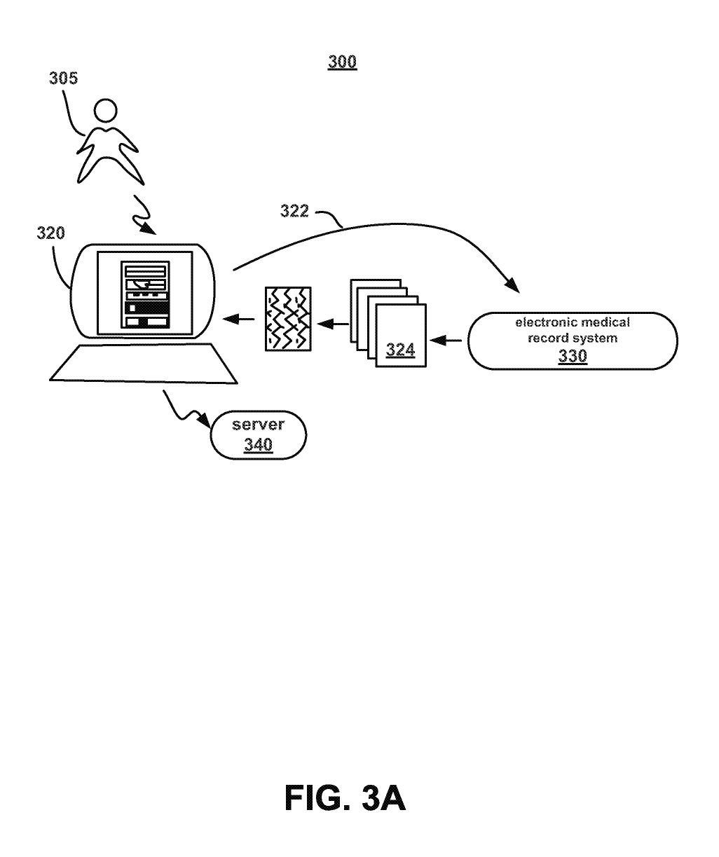

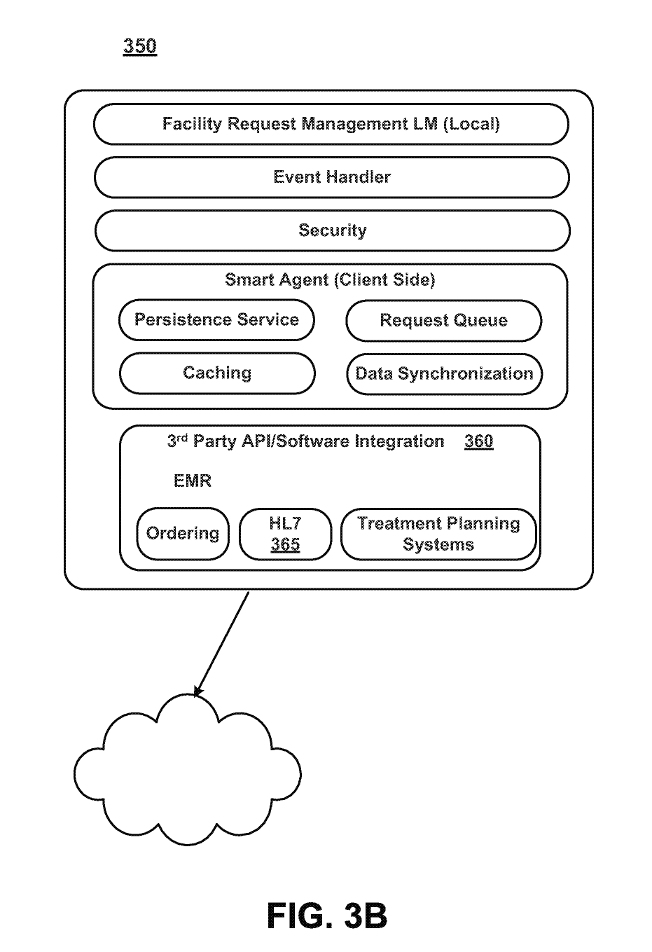

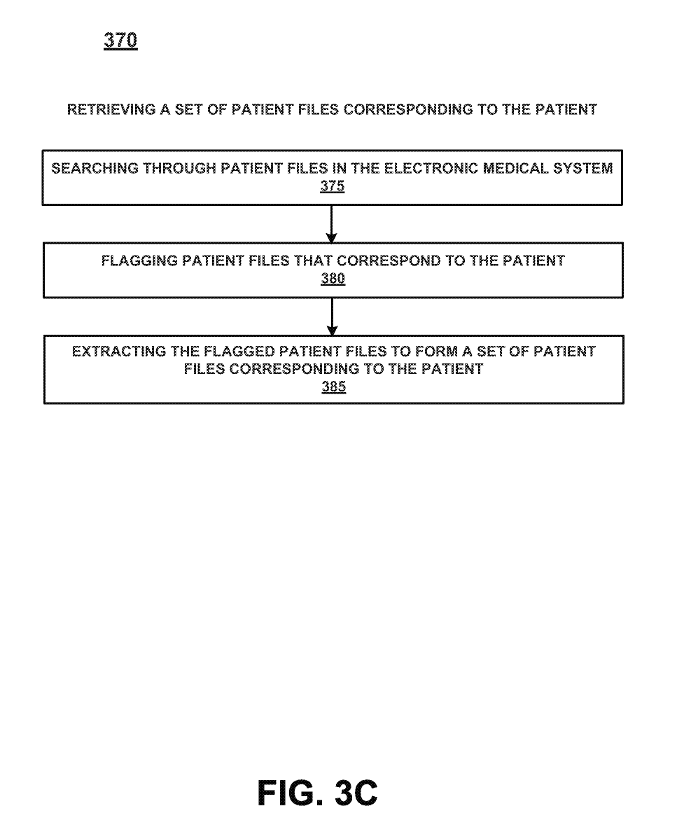

In one embodiment, receiving a set of patient files for the patient (e.g., operation 120 of FIG. 1) functions to gather patient medical files relevant to generating a radiation treatment plan. Reference will be made to elements of FIG. 3A to facilitate the explanation of the operations of operation 120 of FIG. 1. FIG. 3A is a flow diagram of an example schematic for receiving a treatment plan request and receiving a set of patient files 324, in accordance with an embodiment.

At operation 122 of FIG. 1, in one embodiment, an electronic medical record system 330 is interfaced with, as indicated by arrow 322. In one embodiment, the interfacing with the electronic medical record system 330 includes transmitting a request for patient files. Interfacing with an electronic medical system functions to access information required to generate a treatment plan for the patient. As shown in FIG. 3B, interfacing with an electronic medical system includes utilizing an API 360 to communicate with the electronic medical system. In one embodiment, API 360 conforms to Health Level 7 (HL7) standards 365, a protocol aimed to support and ease transitions between healthcare system workflows. In the present embodiment, API 360 conforms to HL7 messaging standards (e.g., HL7 v2.x and HL7 v3.0) that define how to package information in electronic data exchange.

At operation 124, in one embodiment, a set of patient files 324 corresponding to the patient are retrieved from the electronic medical record system 330. Retrieving a set of patient files corresponding to the patient from an electronic medical record system functions to access information required to generate a treatment plan for the patient. In one embodiment, the set of patient files are files conforming to standards set by Digital Imaging Communication in Medicine extended for radiation therapy (DICOM-RT files) that include text, images, and/or graphics relating to radiation therapy, but may alternatively be any suitable kind of patient files. In one embodiment, retrieving from an electronic medical record system a set of patient files corresponding to the patient preferably conforms to the Health Insurance Portability and Accountability (HIPAA) Privacy Rule, which protects the privacy of individually identifiable health information.

FIG. 3C is a flow chart 370 of an example method for retrieving a set of patient files corresponding to the patient from an electronic medical record system, in accordance with various embodiments. Although specific operations are disclosed in the method of flow chart 370, such steps are examples. That is, embodiments of the present invention are well-suited to performing various other operations or variations of the operations recited in method of flow chart 370. The operations in method of flow chart 370 may be performed in an order different than presented, and it is possible that not all of the operations in method of flow chart 370 are performed. All of, or a portion of, the operations described by method of flow chart 370 may be implemented using computer-readable and computer-executable instructions which reside, for example, in computer-usable storage media of a computer system. In one embodiment, flow chart 370 illustrates operations associated with selecting a global service provider as shown in operation 124 of FIG. 1.

At operation 375, patient files in the electronic medical record system are searched. In one embodiment, searching through patient files in the electronic medical record system includes searching through filenames of patient files. In one embodiment, the search is performed without searching through the content of the patient files. At operation 380, patient files that correspond to the patient are flagged, e.g., identified. At operation 385, the flagged patient files are extracted to form a set of patient files corresponding to the patient. Extracting the flagged patient files to form a set of patient files may also include identifying irrelevant files from the set of patient files and discarding the irrelevant files. In an alternative embodiment, retrieving from an electronic medical record system a set of patient files corresponding to the patient may include receiving a set of patient files corresponding to the patient from a user that uploads the set of patient files to a server.

At operation 126, in one embodiment, the set of patient files 324 are bundled with the treatment plan request. Bundling the set of patient files functions to package the set of patient files. Bundling the set of patient files may include compressing the size of the set of patient files, encrypting the set of patient files, and/or adding a priority status label to the bundled files. Bundling the set of patient files may further include bundling the set of patient files with the treatment plan request to create bundled files. At operation 128, in one embodiment, the bundled files are then transmitted to server 230.

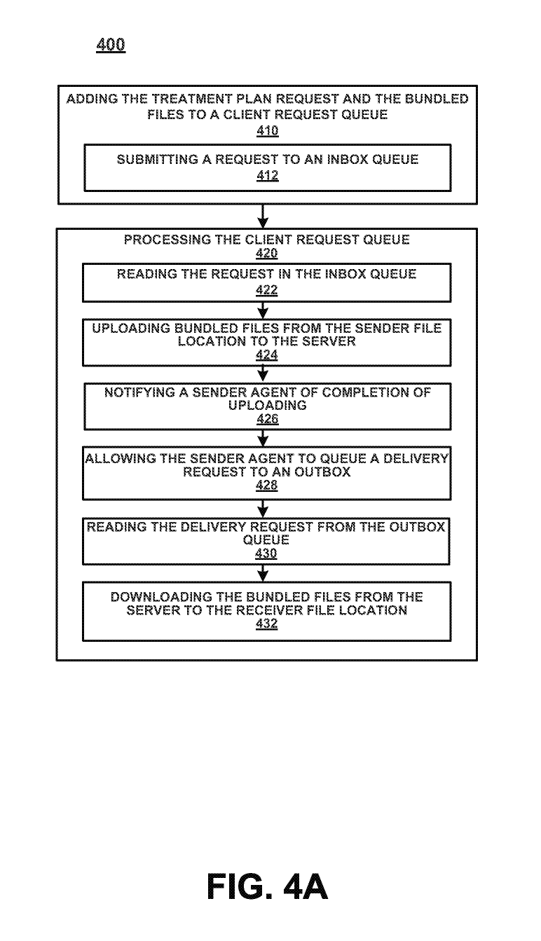

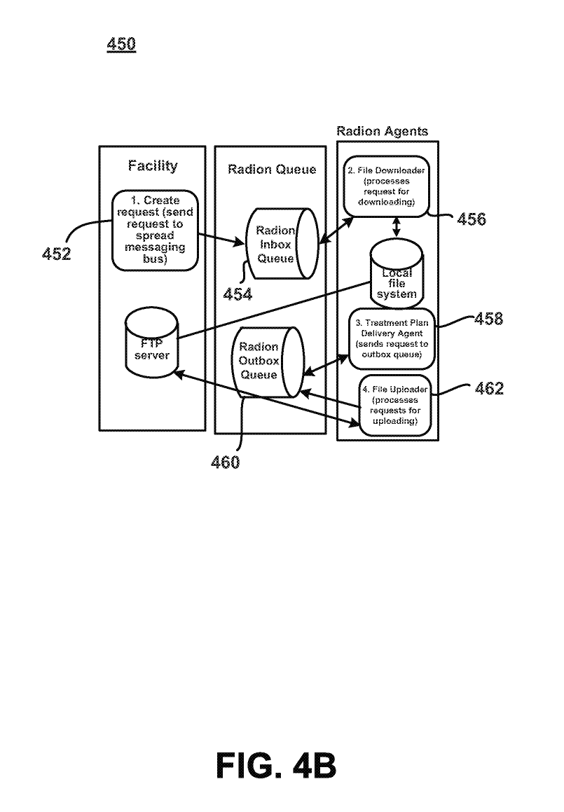

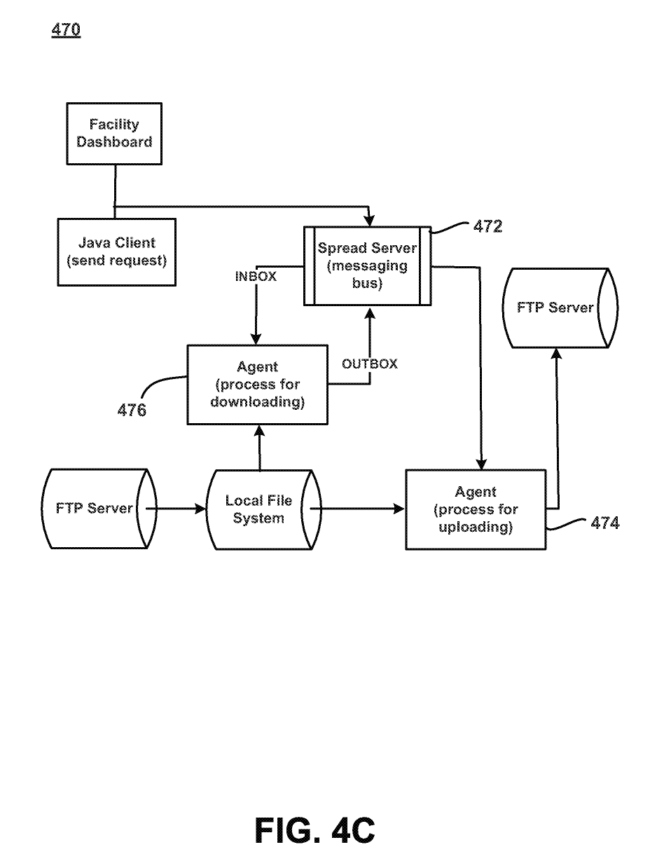

FIG. 4A is a flow chart 400 of an example method for receiving a set of patient files, in accordance with an embodiment. FIG. 4B is a flow diagram 450 of an example schematic for receiving a set of patient files, in accordance with an embodiment. FIG. 4C is a block diagram 470 of an example schematic for receiving a set of patient files, in accordance with an embodiment. Although specific operations are disclosed in the method of flow chart 400, such steps are examples. That is, embodiments of the present invention are well-suited to performing various other operations or variations of the operations recited in method of flow chart 400. The operations in method of flow chart 400 may be performed in an order different than presented, and it is possible that not all of the operations in method of flow chart 400 are performed. All of, or a portion of, the operations described by method of flow chart 400 may be implemented using computer-readable and computer-executable instructions which reside, for example, in computer-usable storage media of a computer system. In one embodiment, flow chart 400 illustrates operations associated with receiving a set of patient files as shown in operations 120 and 140 of FIG. 1.

Reference will be made to elements of FIGS. 4A, 4B and 4C to facilitate the explanation of various operations of operations 120 and 140 of FIG. 1. As shown in FIG. 4A, the operation of transferring the bundled patient files on a server includes adding the treatment plan request and the bundled files to a client request queue, as shown in operation 410. In various embodiments, the bundled files are added to a client request queue in chronological order, but may alternatively be added to the client request queue based on a priority status label, such that bundled files with a priority status label is added closer to the front of the client request queue and processed sooner. However, the bundled files may alternatively be added to the client request queue in any suitable order.

In one embodiment, operation 410 includes operation 412, in which a request (e.g., created at block 452) with a sender file location and a receiver file location on the server is submitted to an inbox queue 454, wherein the request is accompanied by sender information and receiver information. In one embodiment, submitting a request to an inbox queue includes submitting a request to a messaging bus 472, e.g., a messaging bus provided by the Spread Toolkit, an open source messaging service toolkit. In various embodiments, the sender information includes a sender file transfer protocol (FTP) server address, a sender FTP username, a sender FTP password, a sender file location, and/or any suitable information. Similarly, in various embodiments, the receiver information includes a receiver FTP server address, a receiver FTP username, a receiver FTP password, a receiver file location, and/or any suitable information.

At operation 420, the client request queue is processed in a workflow to transfer the treatment plan request and bundled files to a server. In one embodiment, the request is handled by file downloader 456. In one embodiment, processing the client request queue in a workflow to transfer the treatment plan request and bundled files to a server functions to manage the client request queue and oversee transfer of files from the client facility to the server. In various embodiments, on the server, smart agents, including a discovery agent 474, sender agent 476, and receiver agent, are registered with the messaging bus 472 and listening to the client request queue. In various embodiments, the transfer of files occurs over cloud computing service or other suitable network, for instance on a first in, first out basis.

At operation 422, in one embodiment, the request is read in the inbox queue, allowing a discovery agent 474 to upload bundled files from the sender file location to the server. At operation 424, in one embodiment, response to the request read in the inbox queue, a discovery agent 474 uploads the treatment plan request and bundled files from the sender file location (e.g., by file uploader 462). At operation 426, in one embodiment, a sender agent 476 is notified of completion of the upload. At operation 428, in one embodiment, the sender agent 476 is allowed to queue a delivery request to an outbox (e.g., by treatment plan delivery agent 458). At operation 430, in one embodiment, the delivery request is read from the outbox queue (e.g., Radion outbox queue 460). At operation 432, in one embodiment, a receiver agent is allowed to download the bundled files to the receiver location. The treatment plan request and the bundled files may be uploaded to the same server, or may be uploaded to different servers.

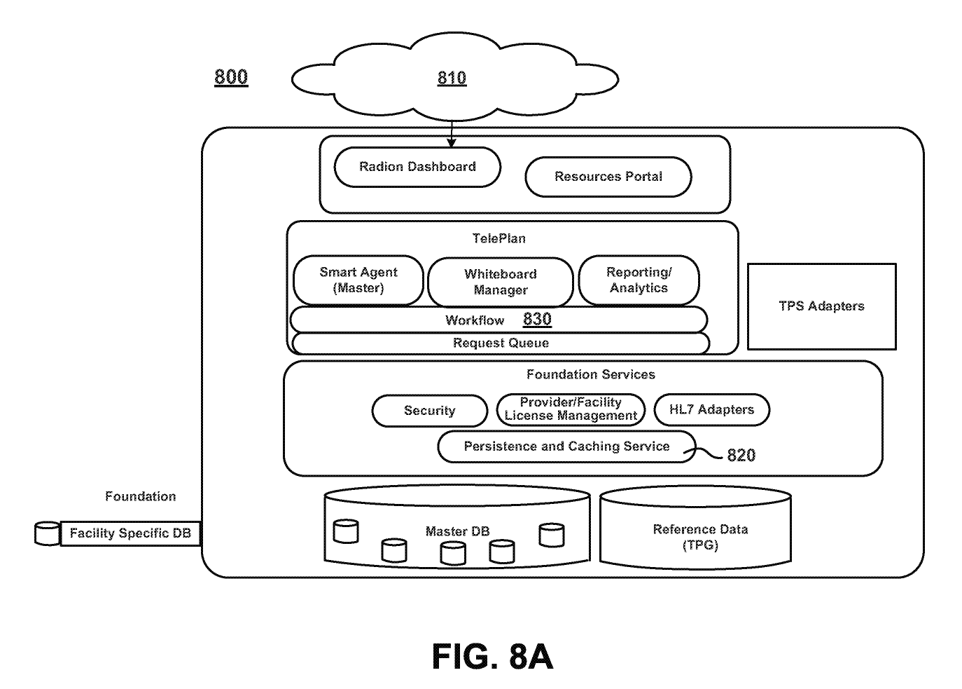

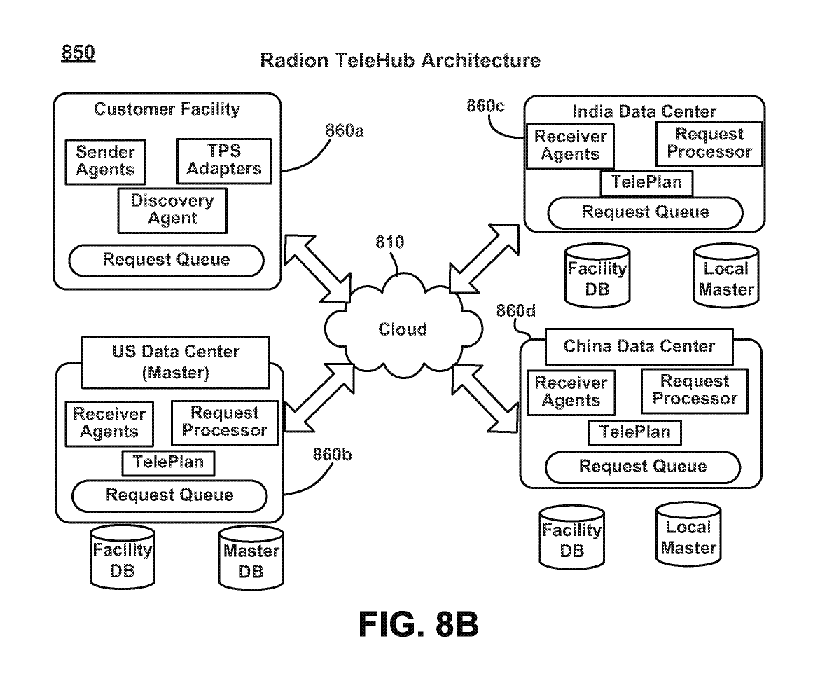

Furthermore, as shown in FIGS. 8A and 8B, the treatment plan request and the bundled files may be uploaded to multiple servers 860a-d. Processing the client request queue further includes providing a persistence service 820 that stores the state of the workflow 830. The persistence service 820 stores the state of the workflow 830 when particular conditions are met, such as when the workflow becomes idle. As an example, the stored state of the workflow may be loaded if the workflow needs to resume from the stored state.

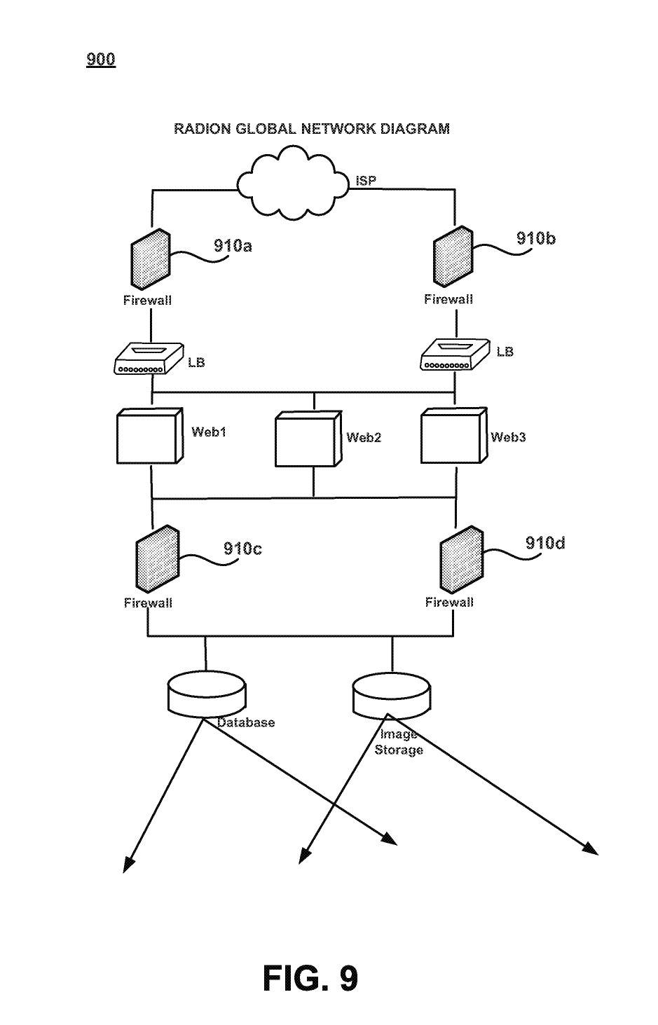

FIGS. 8A and 8B are example schematics of server architectures 800 and 850, respectively, in accordance with an embodiment. FIG. 9 is an example schematic of a network, in accordance with an embodiment. As shown in FIGS. 8A and 9, the online platform is coupled to a data center or server through cloud computing 810 or any suitable network. In various embodiments, the connection incorporates security measures, including using a secure transmission protocol such as Secure Sockets Layer (SSL) and firewalls 910a-d, or any other suitable measures. The server may be a local server located at the client facility or a remote server that stores treatment plan requests and that is preferably compliant with the Health Insurance Portability and Accountability Act (HIPAA) privacy rules. As shown in FIG. 8A, the server includes multiple layers that support various aspects of the treatment planning service, such as the user interface and workflow processing.

In a variation of the method of flow chart 400, the method includes caching the set of patient files. In this variation, bundling the set of patient files with the treatment plan request is similar to that of operation 126 of FIG. 1, except that in this variation, the bundling the set of patient files functions to compile the cached set of patient files with the treatment plan request.

In one embodiment, the method of flow chart 400 may further include processing a return queue which functions to return bundled files and a treatment plan to a local server at the client facility. Processing a return queue is similar to operation 420, except that the roles are reversed. Moreover, it should be appreciated that the recipient in processing a return queue can be the original sender or a third party.

In one embodiment, the server, e.g., server 340 of FIG. 3A, may also act as the server that stores treatment plan requests, or may be a distinct local or remote server that stores patient files. The set of patient files 324 may alternatively be provided by a user that directly uploads the set of patient files to the server 340. In one embodiment, the set of patient files 324 conform to standards set by Digital Imaging Communication in Medicine extended for radiation therapy (DICOM-RT files) and can include, without limitation, text, images, and/or graphics relating to radiation therapy, but may alternatively be any suitable kind of patient files.

Selecting a global service provider from a group of global service providers to handle the treatment planning request functions to designate a global service provider to generate a treatment plan. In one embodiment, a global service provider is a dosimetrist, but may alternatively be any suitable service provider. In one embodiment, the global service provider is one of a group of global service providers that are pre-approved to provide treatment planning services and have access to the data center and/or the file server.

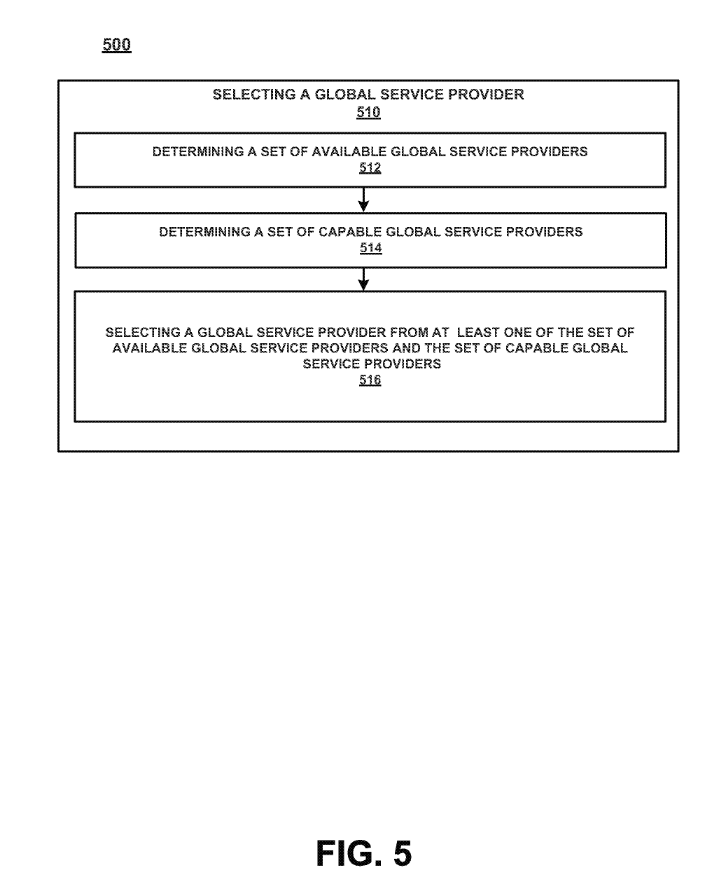

FIG. 5 is a flow chart 500 of an example method for selecting a global service provider. Although specific operations are disclosed in the method of flow chart 500, such steps are examples. That is, embodiments of the present invention are well-suited to performing various other operations or variations of the operations recited in method of flow chart 500. The operations in method of flow chart 500 may be performed in an order different than presented, and it is possible that not all of the operations in method of flow chart 500 are performed. All of, or a portion of, the operations described by method of flow chart 500 may be implemented using computer-readable and computer-executable instructions which reside, for example, in computer-usable storage media of a computer system. In one embodiment, flow chart 500 illustrates operations associated with selecting a global service provider as shown in operation 130 of FIG. 1.

As shown in FIG. 5 at operation 510, in one embodiment, a global service provider is selected. At operation 512, a set of available global service providers is determined. The set of available global service providers is determined based on various considerations, including, but not limited to, identifying global service providers that are currently operating in working hours, such that a treatment planning request is more likely to have a quicker response.

At operation 514, in one embodiment, a set of capable global service providers is determined. The set of capable global service providers is determined based on various considerations, including, but not limited to, identifying global service providers that are capable of generating a treatment plan for a desired kind of radiation therapy (e.g., tomotherapy), and/or with a desired third party treatment planning software tool. It should be appreciated that the sets of available and capable global service providers may be determined independently, or one set may be a subset of the other set

At operation 516, in one embodiment, a global service provider is selected from at least one of the set of available global service providers and the set of capable global service providers. The selection of a global service provider from at least one of the set of available global service providers and the set of capable global service providers is determined based on various considerations, including, but not limited to, determining the average turnaround time for each global service providers of the sets and selecting the global service provider with the minimum average turnaround time, such that a treatment planning request sent to the selected global service provider is expected to have a quicker response. Other example considerations include determining a global service provider with the lowest current volume of treatment plan requests, receiving a user-selected global service provider, or any other suitable consideration.

In one embodiment, providing the treatment plan request to the selected global service provider (e.g., operation 140 of FIG. 1) functions to provide the selected global service provider access to the treatment plan request and to the set of patient files. At operation 142, the selected global service provider is notified of the treatment plan request. In various embodiments, notifying the selected global service provider of the treatment plan request may be performed through email, online instant message system, phone, fax, or any suitable notification system. At operation 144, the global service provider is allowed access to the server. In one embodiment, allowing access to the server includes allowing the global service provider to access the web browser for the online platform that is coupled to the server, which can include security measures such as a login username, user ID, and/or password.

With reference to FIGS. 2A and 2B, at operation 280, in one embodiment, a recommended treatment plan is provided. In one embodiment, providing a recommended treatment plan functions to generate a recommended radiation distribution customized to the tumor characteristics. Providing a recommended treatment plan includes providing a recommended treatment plan from a smart prescription engine database. The smart prescription engine database is preferably on a server, which may be a local or a remote server. In one embodiment, the recommended treatment plan 222 is added to the prescription file of FIG. 2A.

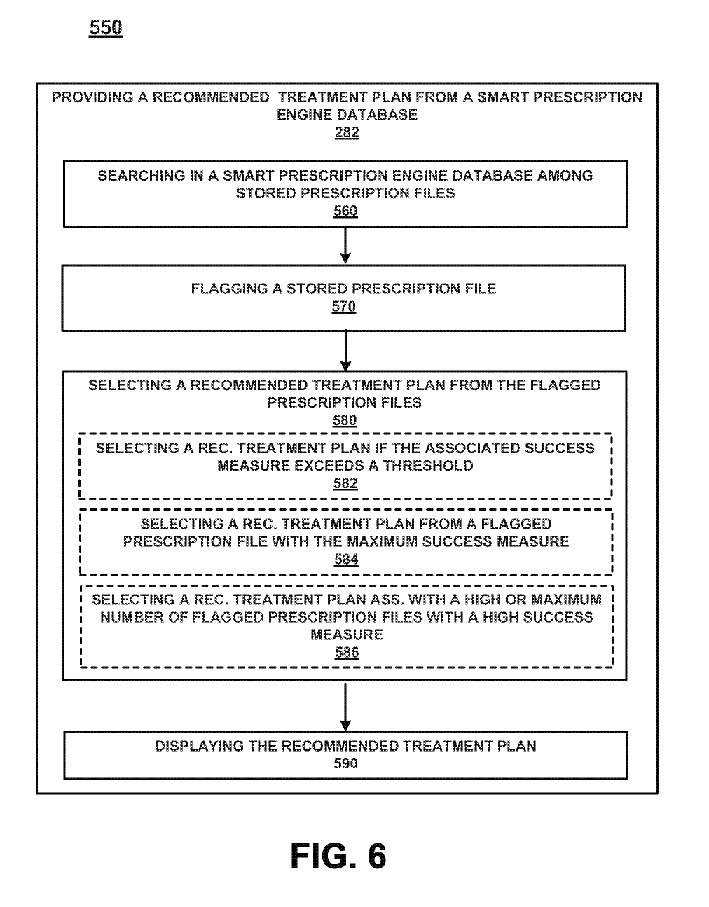

FIG. 6 is a flow chart 550 of an example method for providing a recommended treatment plan from a smart prescription engine database, in accordance with various embodiments. Although specific operations are disclosed in the method of flow chart 550, such steps are examples. That is, embodiments of the present invention are well-suited to performing various other operations or variations of the operations recited in method of flow chart 550. The operations in method of flow chart 550 may be performed in an order different than presented, and it is possible that not all of the operations in method of flow chart 550 are performed. All of, or a portion of, the operations described by method of flow chart 550 may be implemented using computer-readable and computer-executable instructions which reside, for example, in computer-usable storage media of a computer system. In one embodiment, flow chart 550 illustrates operations associated with providing a recommended treatment plan from a smart prescription engine database as shown in operation 282 of FIG. 2B.

As shown in FIG. 6, operation 282 includes searching in a smart prescription engine database among stored prescription files having an associated tumor classification and an associated set of critical dose structures, as shown in operation 560, wherein a stored prescription file includes an associated treatment plan and an associated treatment plan success measure.

At operation 570, a stored prescription file is flagged if its associated tumor classification and associated set of critical dose structures match the tumor classification and the set of critical dose structures.

At operation 580, a recommended treatment plan is selected from the flagged prescription files based on its associated treatment plan success measure. It should be appreciated that operation 580 may be performed according to one of several variations. In a first variation, as shown at operation 582, selecting a recommended treatment plan includes selecting a recommended treatment plan from a flagged prescription file if the associated treatment plan success measure of a flagged prescription file exceeds a threshold. In a second variation, as shown at operation 584, selecting a recommended treatment plan includes selecting a recommended treatment plan from a flagged prescription file with the maximum associated treatment plan success measure among the flagged prescription files. In a third variation, as shown at operation 586, selecting a recommended treatment plan includes selecting the recommended treatment plan that is associated with a high or maximum number of flagged prescription files that have high treatment plan success measures (e.g., the most frequently successful), wherein a comparative threshold may be used in the determination of a high number of flagged prescription files and/or the determination of a high treatment plan success measure. However, it should be appreciated that the selection of a recommended treatment plan may include any other suitable method.

With reference to FIG. 2B, at operation 284, in another embodiment, providing a recommended treatment plan includes retrieving a treatment plan from a lookup table based on a protocol. Retrieving a treatment plan from a lookup table based on a protocol, in one embodiment, includes retrieving a treatment plan from a lookup table populated by the Radiation Therapy Oncology Group (RTOG) protocol, based on the tumor classification and/or the set of critical dose structures.

At operation 286, in another embodiment, providing a recommended treatment plan includes retrieving a stored treatment plan template. In one embodiment, the template includes default and/or user preferences for maximum and minimum radiation dosages for at least one critical dose structure.

At operation 287, in another embodiment, providing a recommended treatment plan includes interfacing with a third party treatment planning system, and retrieving a treatment plan from the third party treatment planning system.

At operation 288, providing a recommended treatment plan includes receiving a manual treatment plan, and may further include storing the manual treatment plan as a stored treatment template, providing a recommended treatment plan from a smart prescription engine database, and/or adjusting the manual treatment plan based on the recommended tumor treatment plan. In one embodiment, the stored treatment plan template is stored in a user template database that corresponds to a user, but may additionally and/or alternatively be stored in a facility template database that corresponds to a treatment facility. In one embodiment, the manual treatment plan can be adjusted based on the recommended treatment plan, including modifying the maximum radiation dosage and/or minimum radiation dosage for at least one critical dose structure to match or more closely approximate the maximum radiation dosage and/or minimum radiation dosage for the critical dose structure in the recommended treatment plan. In the present embodiment, the method may further include creating a metric that evaluates the similarity between the manual treatment plan and the recommended treatment plan. The metric may be used, for example, to provide performance feedback for a user.

It should be appreciated that providing a recommended treatment plan may, however, include any suitable combination or permutation of the above steps and/or any other operations, and is not limited to the described embodiments.

With reference to FIG. 6A, at operation 590, the recommended treatment plan is displayed on the user interface. In various embodiments, a treatment plan includes a set of maximum radiation dosages and/or minimum radiation dosages corresponding to each of the set of critical dose structures, such that each critical dose structure is provided with an acceptable range of radiation dosage that is displayed on the user interface, but a treatment plan may additionally and/or alternatively include beam shape, beam intensity, beam angle, and/or any suitable information related to radiation treatment. The collection of stored prescription files in the smart prescription engine database may have distinct associated treatment plans, or at least a portion of the stored prescription files in the smart prescription engine database may have identical associated treatment plans.

With reference to FIG. 2B, at operation 290, in one embodiment, a treatment plan success measure is received based on the result of executing the recommended treatment plan. In one embodiment, receiving a treatment plan success measure based on the result of executing the recommended treatment plan functions to receive an evaluation of the effectiveness of the recommended treatment plan. This operation is generally performed after the treatment plan is executed on the patient and after the tumor is imaged or otherwise monitored to evaluate progress of the tumor. In one embodiment, the treatment plan success measure 224 is added to the prescription file of FIG. 2A.

At operation 295, in one embodiment, the prescription file and treatment plan success measure in a prescription engine database. In one embodiment, storing the prescription file and treatment plan success measure in the smart prescription engine database functions to provide more data in the smart prescription engine database. In one embodiment, flow chart 250 further includes reviewing the prescription file for errors. Embodiments of the method of flow chart 250 are suited to quickly and reliably generate a tumor treatment plan, at least partially based on prior patterns of successful tumor treatment plans. As described above, in various embodiments, the method is performed by a processor coupled to a user interface, such that a dosimetrist, physician, or any suitable user may interact with the user interface.

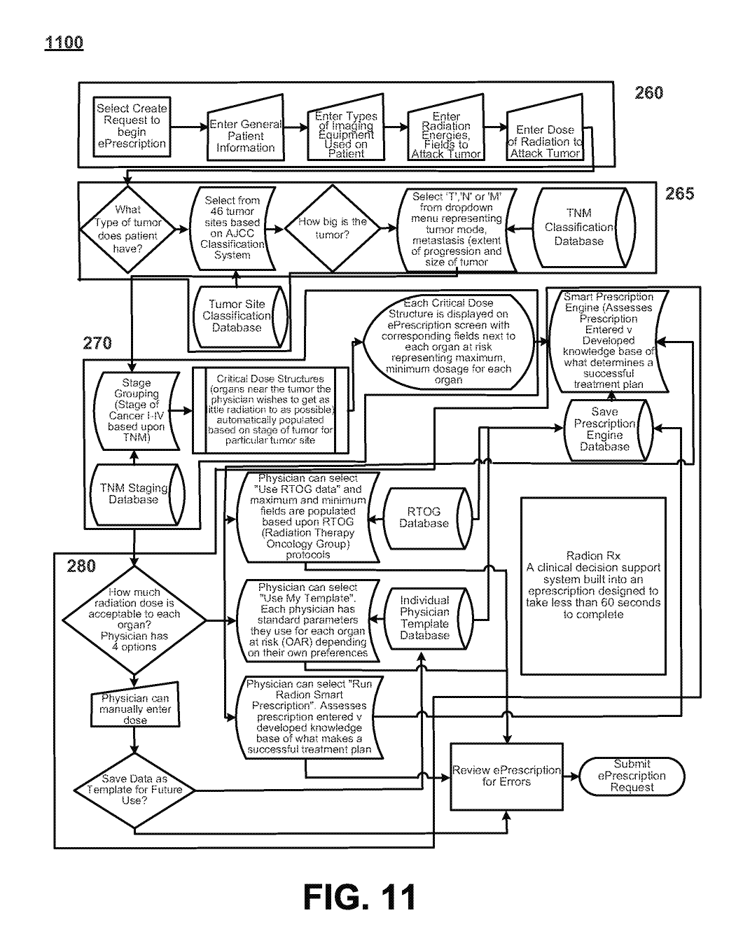

FIG. 11 is a block diagram 1100 of an example creation of a treatment plan request, in accordance an embodiment. Block diagram 1100 illustrates a detailed example of the operation of flow chart 250 of FIG. 2B, in accordance with one embodiment.

In one embodiment, providing the treatment plan to the client facility (e.g., operation 160 of FIG. 1) functions to send a response to the treatment plan request to the client facility. In one embodiment, the treatment plan and the bundled files are transmitted to a server at the client facility. In one embodiment, transferring the treatment plan and the bundled files to a server at the client facility is performed in a similar manner as detailed in flow chart 400 of FIG. 4A, except that the roles in transferring the treatment plan and the bundled files to a server at the client facility are reversed.

In some embodiments, the method of flow chart 100 further includes operation 170 at which the status of the treatment plan request is monitored. In various embodiments, monitoring the status of the treatment plan request includes receiving indications of completion of milestones, displaying a graphical representation of the treatment plan request milestones, and updating the graphical representation in response to completion of milestones.

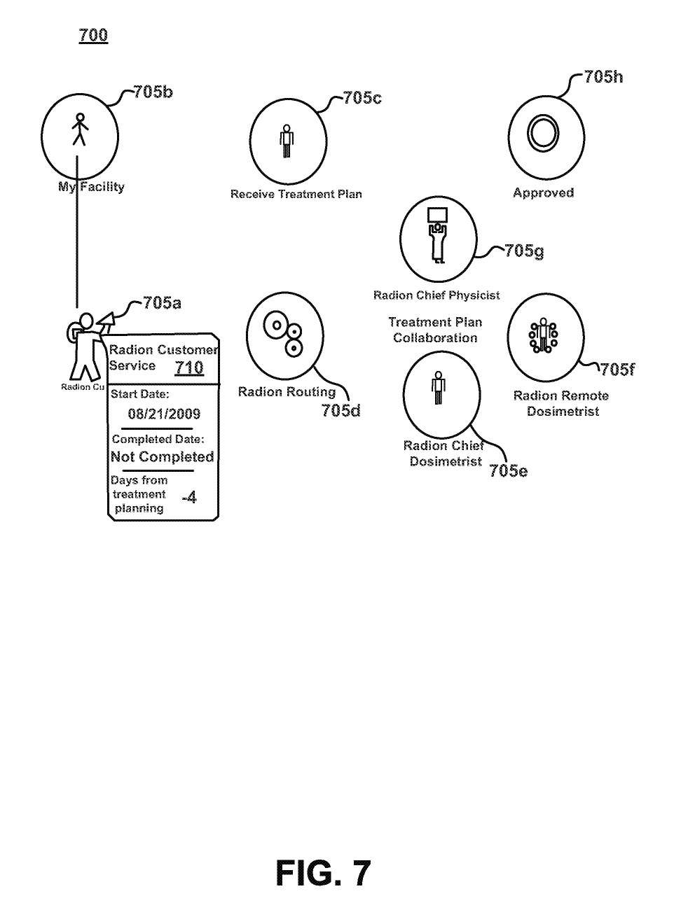

FIG. 7 is an example graphical representation 700 for monitoring status of the treatment plan request, in accordance with an embodiment. In one embodiment, graphical representation 700 is rendered on a monitor of a computer system for presentation to a user. As shown in FIG. 7, the graphical representation includes a process flow with markers 705a-h representing milestones and an icon 710 positioned at the marker representing the current pending milestone in the flow diagram, e.g., icon 710 is positioned at marker 705a in the illustrated embodiment. Icon 710 may include text including treatment plan information, such as start date, completion date, and current pending milestone. Milestones may include creation of the treatment plan request, selection of the global service provider, providing the treatment plan request to the global service provider, completion of the treatment plan, and providing the treatment plan to the client facility.

In other embodiments, graphical representation 700 may include a checklist of milestones, a pie chart representing the number of milestones completed, or any suitable graphical representation. Monitoring the status of the treatment plan request may additionally and/or alternatively include notifying a user of problems (e.g., if no appropriate global service provider is found, the bundled files cannot be located, and creation of the treatment plan is taking longer than expected) and storing metrics about the selected global service provider (e.g., calculated turnaround time for the selected global service provider and volume of treatment plan requests currently provided to the selected global service provider).

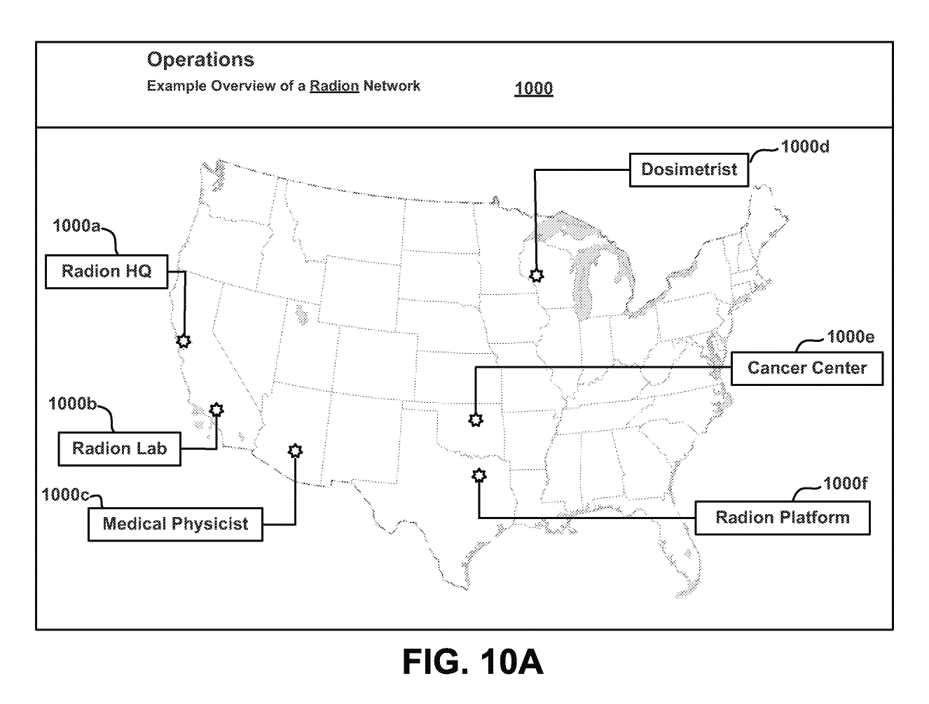

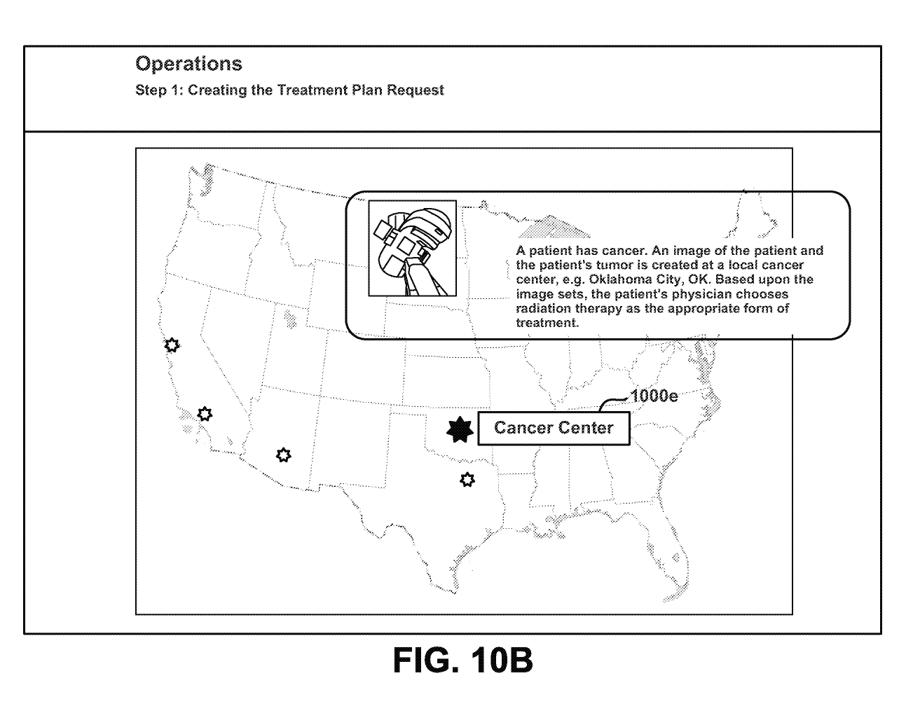

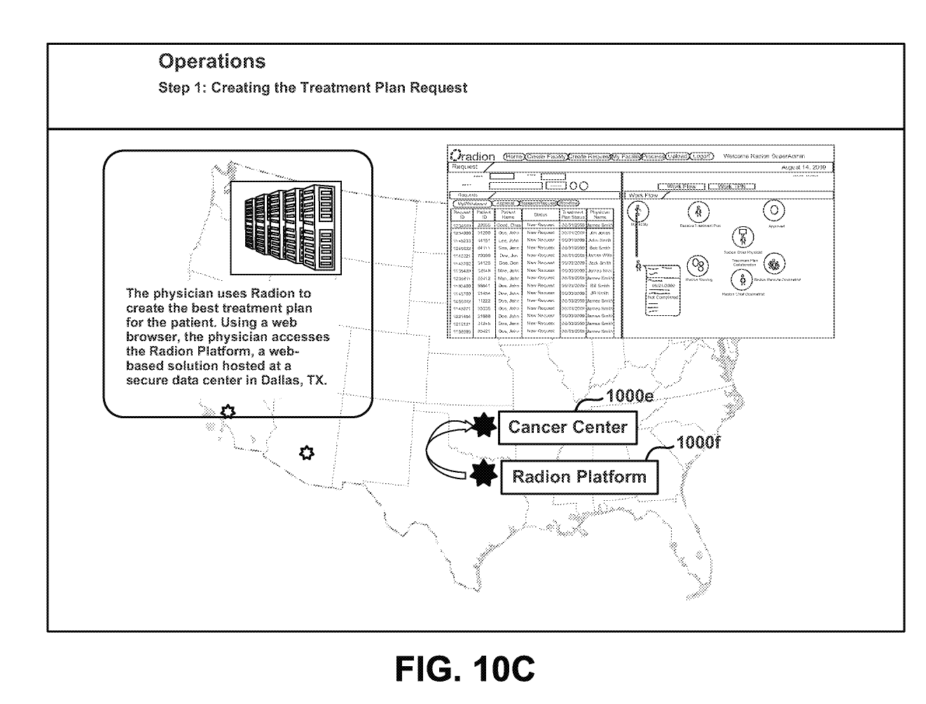

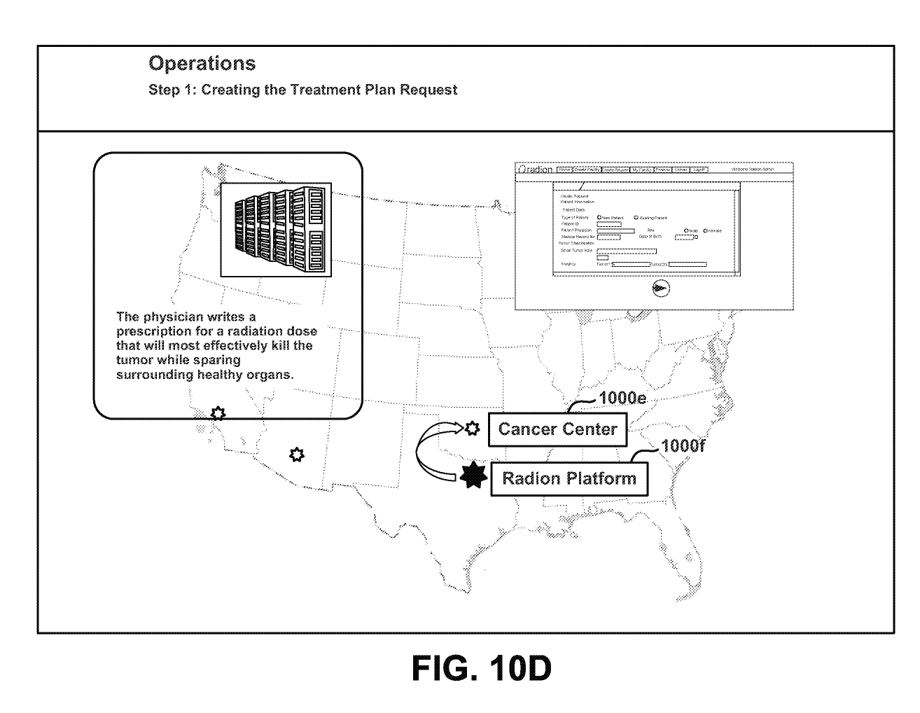

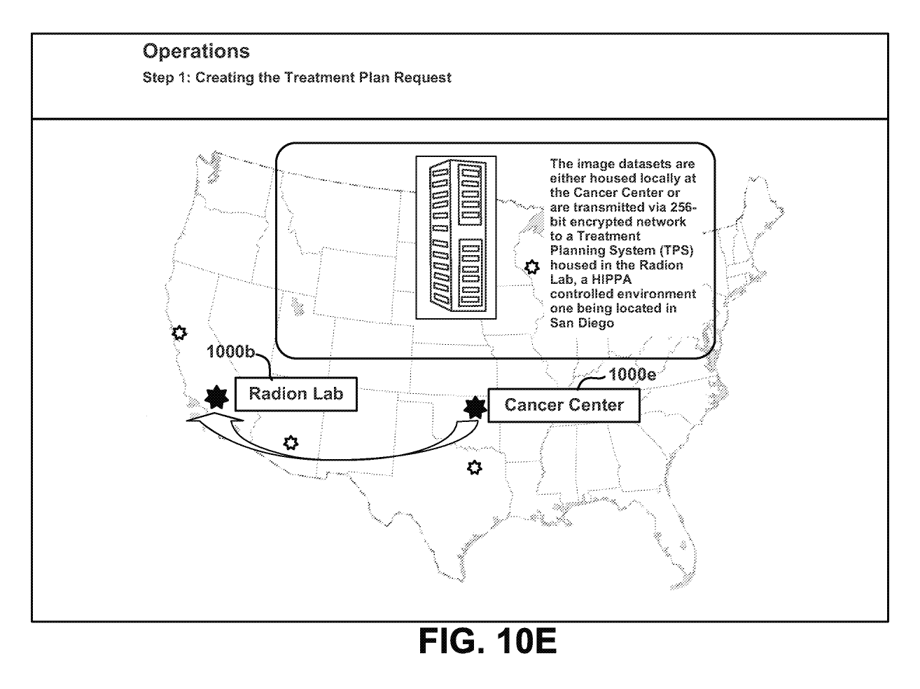

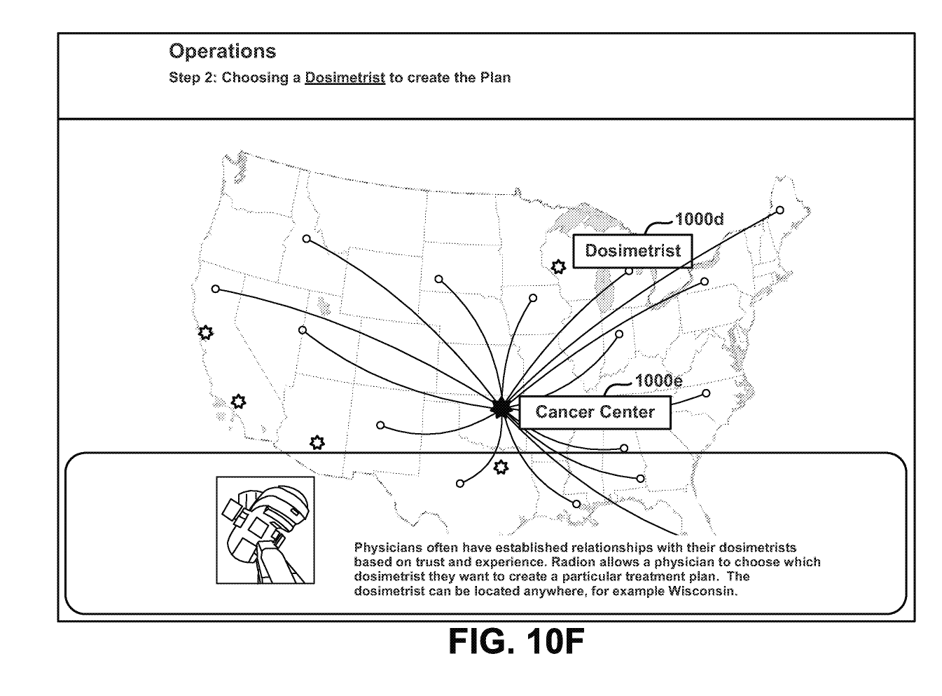

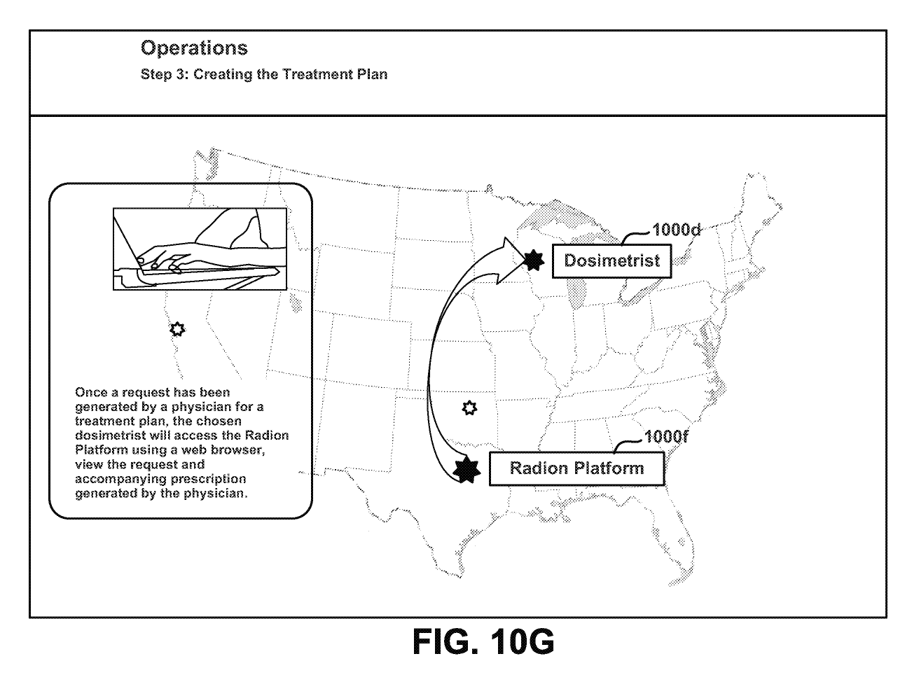

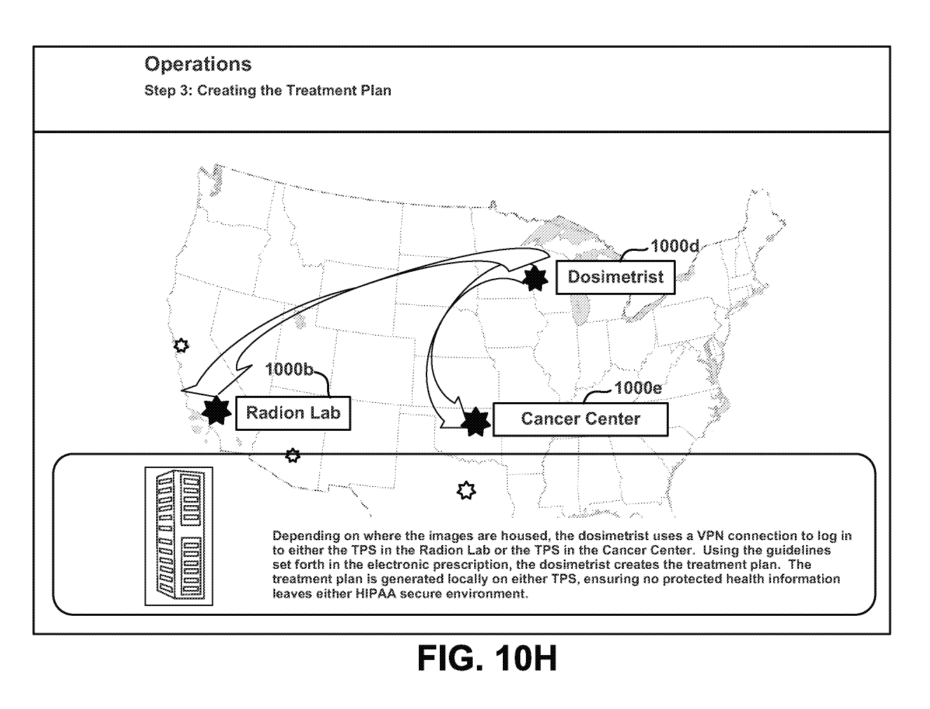

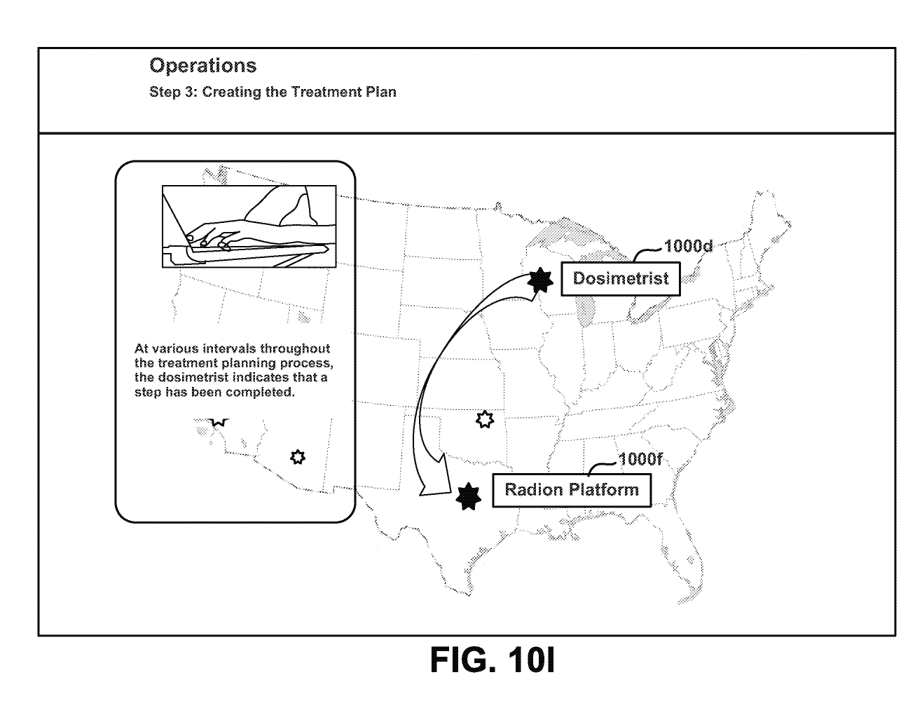

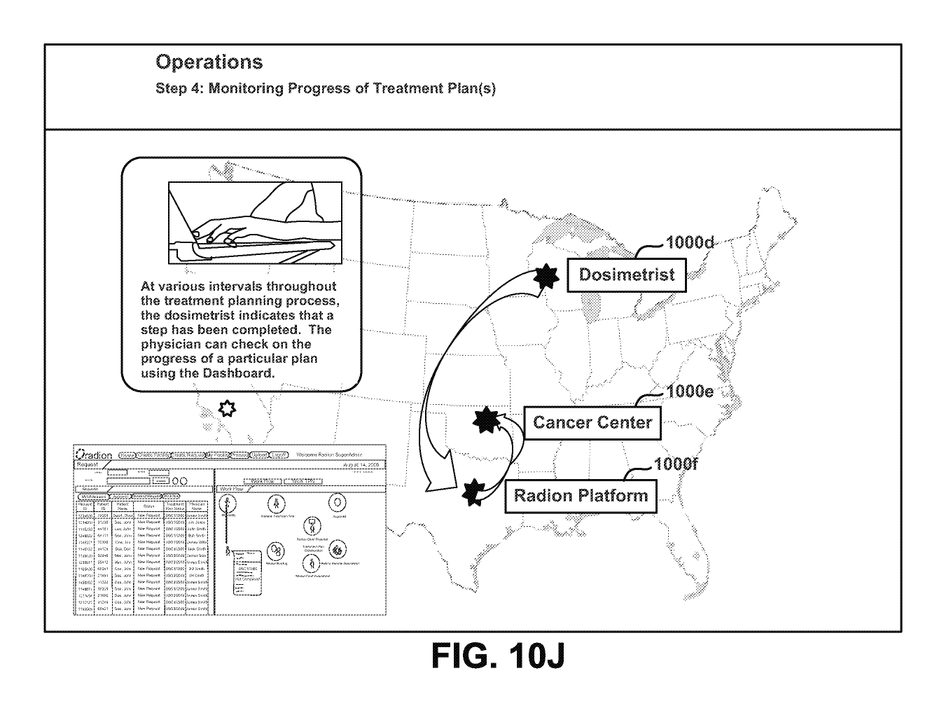

FIGS. 10A-10J are schematics illustrating an example method for providing a radiation treatment planning service. As shown in FIGS. 10A-10J, in an example of the method, the client facility, the dosimetrist, and servers may be located in different geographic areas during execution of the method. FIG. 10A illustrates an example network of participants, as shown distributed across the United States of America. In the present embodiment, network 1000 includes Radion headquarters 1000a, Radion lab 1000b, medical physicist 1000c, dosimetrist 1000d, cancer center 1000e, and Radion platform 1000f, each of which are located in different geographic locations. It should be appreciated, in various embodiments, that at least two participants can be located in the same geographic location.

FIGS. 10B-10E illustrate creating a treatment plan request. At FIG. 10B, a patient with cancer visits cancer center 1000e, located in Oklahoma City, Okla., and an image of the patient and the patient's tumor are created. Based upon the image sets, the patient's physician chooses radiation therapy as an appropriate form of treatment. At FIG. 10C, the physician uses Radion to create the treatment plan for the patient. Using a web browser, the physician accesses the Radion platform 1000f, a web-bases solution at a secure data center in Dallas, Tex. At FIG. 10D, the physician writes a prescription for a radiation dose. At FIG. 10E, the image data sets are housed either locally at cancer center 1000e or are transmitted via a 256-bit encrypted network to a TPS house in Radion lab 1000b, located in San Diego, Calif. Radion lab 1000b is a HIPAA controlled environment.

At FIG. 10F, a dosimetrist is selected to create the treatment plan. Physicians often have established relationships with dosimetrists. A dosimetrist may be selected by the physician and can be located anywhere. As shown in the instant example, dosimetrist 1000d is located in rural Wisconsin.

FIGS. 10G-10I illustrate creating a treatment plan At FIG. 10G, the treatment plan is created. Once a request has been generated by a physician for a treatment plan, the chosen dosimetrist 1000d will access the Radion platform 1000f using a web browser and view the request and accompanying prescription generated by the physician. At FIG. 10H, depending on where the images are housed, dosimetrist 1000d uses a virtual private network (VPN) connection to log in to either the TPS in Radion lab 1000b or in cancer center 1000e. Using guidelines set forth in the electronic prescription, dosimetrist 1000d creates the treatment plan. The treatment plan is generated locally on either TPS, ensuring that no protected health information leaves either HIPAA secure environment. As shown in FIG. 10I, at various intervals throughout the treatment planning process, dosimetrist 1000d indicates the completion of various steps.

At FIG. 10J, the progress of the treatment plan(s) is monitored. At various intervals throughout the treatment planning process, dosimetrist 1000d indicates the completion of various steps. The physician can check on the progress of a particular treatment plan be accessing the TPS.

As a person skilled in the art will recognize from the previous detailed description and from the figures and claims, modifications and changes can be made to the preferred embodiments of the invention without departing from the scope of this invention defined in the following claims. The foregoing descriptions of specific embodiments have been presented for purposes of illustration and description. They are not intended to be exhaustive or to limit the presented technology to the precise forms disclosed, and obviously many modifications and variations are possible in light of the above teaching. The embodiments were chosen and described in order to best explain the principles of the presented technology and its practical application, to thereby enable others skilled in the art to best utilize the presented technology and various embodiments with various modifications as are suited to the particular use contemplated.

What is claimed is:

1. A computer-implemented method for planning a radiation treatment, said method comprising:
receiving a treatment plan request at a computer system, said treatment plan request comprising patient identification information for a patient, said treatment plan request for requesting creating of a treatment plan for use in radiation therapy;
receiving patient files corresponding to said patient at said computer system, said patient files comprising information for use in creating said treatment plan;
selecting a service provider for creating a treatment plan at said computer system; and
providing said service provider access to said patient files and said treatment plan request.

2. The method of claim 1 wherein said treatment plan request comprises a prescription file comprising said patient identification information, general treatment information, and tumor classification information.

3. The method of claim 1 wherein said receiving said patient files comprises:
interfacing with an electronic medical record system;
retrieving said patient files corresponding to said patient;
bundling said patient files with said treatment plan request; and
transferring bundled files to a server.

4. The method of claim 3 wherein said retrieving said patient files corresponding to said patient comprises:
searching through a plurality of patient files in said electronic medical record system;
flagging said patient files corresponding to said patient; and
extracting flagged patient files to form said patient files corresponding to said patient.

5. The method of claim 3 wherein said transferring said bundled files to said server comprises:
adding said treatment plan request and said bundled files to a client request queue, said treatment plan request submitted to an inbox queue;
processing said client request queue, said processing comprising:
accessing said treatment plan request at said inbox queue;
uploading said bundled files from a sender file location said server;
notifying a sender agent upon completion of said uploading;
allowing said sender agent to queue a delivery request to an outbox;
accessing said delivery request from an outbox queue; and
downloading said bundled files from said server to a receiver file location.

6. The method of claim 1 wherein said selecting a service provider for creating a treatment plan comprises:
determining a set of available service providers;
determining a set of capable service providers; and
selecting a service provider from at least one of said set of available service providers and said set of capable service providers.

7. The method of claim 1 wherein said providing said service provider access to said patient files and said treatment plan request comprises:
notifying said service provider of selection to provide said treatment plan; and
allowing said service provider access to a server for access to said patient files and said treatment plan request.

8. The method of claim 1 wherein said service provider is a dosimetrist.

9. The method of claim 1 wherein said patient files conform to standards set by Digital Imaging Communication in Medicine extended for radiation therapy (DICOM-RT).

10. The method of claim 1 further comprising receiving a treatment plan from said service provider.

11. The method of claim 10 further comprising providing said treatment plan to a client facility.

12. The method of claim 1 further comprising monitoring status of said treatment plan request.

13. A non-transitory computer-readable storage medium having computer-readable instructions stored thereon, which, when executed, caused a computer system to perform a method for planning a radiation treatment, said method comprising
receiving a treatment plan request, said treatment plan request comprising comprises a prescription file comprising said identification information, general treatment information, and tumor classification information for a patient, said treatment plan request for requesting creating of a treatment plan for use in radiation therapy;
receiving patient files corresponding to said patient, said patient files comprising information for use in creating said treatment plan, wherein said patient files conform to standards set by Digital Imaging Communication in Medicine extended for radiation therapy (DICOM-RT);
selecting a service provider for creating a treatment plan, wherein said selecting a service provider for creating a treatment plan comprises:
determining a set of available service providers;
determining a set of capable service providers; and
selecting a service provider from at least one of said set of available service providers and said set of capable service providers;
providing said service provider access to said patient files and said treatment plan request, wherein said providing said service provider access to said patient files and said treatment plan request comprises:
notifying said service provider of said treatment plan request; and
allowing said service provider access to a server for access to said patient files and said treatment plan request; and
receiving a treatment plan from said service provider.

14. The computer-readable storage medium of claim 13 wherein said receiving said patient files comprises:
interfacing with an electronic medical record system;
retrieving said patient files corresponding to said patient;
bundling said patient files with said treatment plan request; and
transferring bundled files to a server.

15. The computer-readable storage medium of claim 13 wherein said service provider is a dosimetrist.

16. The computer-readable storage medium of claim 13 wherein said service provider and said server are in different geographic locations.

17. The computer-readable storage medium of claim 13 wherein said method further comprises receiving a treatment plan from said service provider.

18. The computer-readable storage medium of claim 13 wherein said method further comprises providing said treatment plan to a client facility.

19. The computer-readable storage medium of claim 13 wherein said method further comprises monitoring status of said treatment plan request.

20. A computer-implemented method for planning a radiation treatment, said method comprising:
receiving a treatment plan request at a computer system, said treatment plan request comprising comprises a prescription file comprising patient identification information, general treatment information, and tumor classification information for a patient, said treatment plan request for requesting creating of a treatment plan for use in radiation therapy, wherein said receiving said patient files comprises:
interfacing with an electronic medical record system;
retrieving said patient files corresponding to said patient;
bundling said patient files with said treatment plan request; and
transferring bundled files to a server;
receiving patient files corresponding to said patient at said computer system, said patient files comprising information for use in creating said treatment plan, wherein said patient files conform to standards set by Digital Imaging Communication in Medicine extended for radiation therapy (DICOM-RT);
selecting a dosimetrist for creating a treatment plan at said computer system, wherein said dosimetrist and said server are in different geographic locations, wherein said selecting said dosimetrist comprises:
determining a set of available dosimetrists;
determining a set of capable dosimetrists; and
selecting a dosimetrist from at least one of said set of available dosimetrists and said set of capable dosimetrists; and
providing said dosimetrist with access to said patient files and said treatment plan request, wherein said providing said dosimetrist access to said patient files and said treatment plan request comprises:
notifying said dosimetrist of selection to provide said treatment plan; and
allowing said dosimetrist with access to said server for access to said patient files and said treatment plan request; and
receiving a treatment plan from said dosimetrist.
